(19) United States
(12) Patent Application Publication
(10) Pub. No.: US 2024/0330765 A1
(43) Pub. Date: Oct. 3, 2024

(54) EFFICIENT FEATURE MERGING AND AGGREGATION FOR PREDICTIVE TRAITS

(71) Applicant: Twilio Inc., San Francisco, CA (US)

(72) Inventors: Carlos Alberto Oliveira, San Diego, CA (US); Alfredo Lainez Rodrigo, Madrid (ES); Rowan Michael Wing, Longmont, CO (US); Maria del Pilar Fernandez Gallego, Madrid (ES); Sebastian Montes, Madrid (ES); Akshay Chandrashekaran, Boston, MA (US); Ankit Awasthi, San Francisco, CA (US)

(21) Appl. No.: 18/441,140

(22) Filed: Feb. 14, 2024

(30) Foreign Application Priority Data
Mar. 28, 2023 (ES) P202330260
Aug. 23, 2023 (ES) P202330706

(51) Int. Cl. G06N 20/00; G06N 5/022

(52) U.S. Cl. CPC G06N 20/00; G06N 5/022

(57) ABSTRACT

System and method including accessing a feature associated with a plurality of user identities (IDs); accessing a structure specifying mappings between the plurality of user IDs and a plurality of user canonical IDs; generating groups of feature values of the feature based on the mappings, each group of feature values being associated with a corresponding group of user IDs and with a corresponding user canonical ID; aggregating each group of feature values to calculate an aggregate feature value of the feature, each aggregate feature value associated with the corresponding user canonical ID; computing predictive traits associated with the plurality of user canonical IDs, the predictive traits including likelihoods of events or trait values, the computation of the predictive traits using the aggregate feature values associated with the corresponding user canonical IDs; and causing display, at a user interface (UI) of a computing device, of the computed predictive traits.

### CROSS-REFERENCE TO RELATED APPLICATIONS

This application claims the benefit of Spanish Application No. P202330706, filed on Aug. 23, 2023, which is hereby incorporated by reference in its entirety. This application also claims the benefit of Spanish Application No. P202330260, filed on Mar. 28, 2023, which is hereby incorporated by reference in its entirety.

### TECHNICAL FIELD

The disclosed subject matter relates generally to the technical field of machine learning and, in one specific example, to feature generation and processing solutions in the context of predicting traits or behaviors of a user of a computer system.

### BACKGROUND

Developing high performance machine learning (ML) models for specific predictive or classification goals frequently relies on feature generation and processing pipelines that take into account characteristics of the prediction or classification tasks, as well as properties of available data used for model development.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a network diagram illustrating a system within which various example embodiments may be deployed.

FIG. 2 is a block diagram illustrating a feature generation system, according to some examples.

FIG. 3 is a block diagram illustrating a view of a predictive trait system that includes a framework for training, evaluating and/or deploying trait prediction models, according to some examples.

FIG. 4 is a block diagram illustrating a view of a predictive trait system that includes a framework for training, evaluating, and/or deploying trait prediction models, according to some examples.

FIG. 5 is a diagram illustrating a view of a user interface (UI) for a predictive trait system, according to some examples.

FIG. 6 is a diagram illustrating a view of a predictive trait selection within a UI for a predictive trait system, according to some examples.

FIG. 7 is a diagram illustrating a view of a predictive trait configuration within a UI for a predictive trait system, according to some examples.

FIG. 8 is a diagram illustrating a visualization of data related to trait prediction results in a predictive trait system, according to some examples.

FIG. 9 is a diagram illustrating a visualization of data related to trait prediction results in a predictive trait system, according to some examples.

FIG. 10 is a block diagram illustrating an example of a software architecture that may be installed on a machine, according to some example embodiments.

FIG. 11 is a block diagram illustrating components of a machine, according to some example embodiments, able to read instructions from a machine-readable medium (e.g., a machine-readable storage medium) and perform any one or more of the methodologies discussed herein.

FIG. 12 is a block diagram showing a machine-learning program, according to some examples.

FIG. 13 is a flowchart illustrating a method for feature generation, as implemented by a feature generation system, according to some examples.

### DETAILED DESCRIPTION

Developers building predictive models using features and/or prediction variables with a temporal component often integrate historical data, such as past user behavior or past events, into model development and training. For example, when predicting the probability associated with the future occurrence of a certain event such as a conversion event, a user's future purchase in a certain purchase category, or a user's repeat purchase, a predictive machine learning (ML) model can use features derived from a past event stream, such as the history of the user's interactions with a retailer's website or with an e-commerce platform. However, user behavior information can be fragmented across different views, personas, and/or IDs associated with the same user. Each such persona, view or ID can have an associated set of ID-level features, such as features derived from associated event streams (e.g., a stream of user interactions with a retailer while a user is logged in to a specific account on a specific device). For example, a user can log into an account on a mobile device and engage in a series of interactions with a retailer, including viewing a series marketing e-mails, clicking on various pages on the retailer website, and/or other interactions. The next day, the same user can use an account on a desktop to complete a purchase on the retailer's website, taking advantage of a previously viewed promotion. A system for building predictive models can benefit from identifying IDs corresponding to the same underlying entities (e.g., users) and aggregating and/or combining ID-level feature information to compute entity-level features. The use of such comprehensive user behavior can lead to a more accurate domain representation, less sparse data, and/or better prediction performance. However, if merging IDs is a regular or frequent occurrence, retroactively updating each ID-level event stream or other low-level information derived from the event streams to reflect each merged set of IDs can be expensive and/or inefficient at scale. Therefore, a system building and/or deploying predictive models for retailers with large or frequently updating consumer populations needs a feature generation solution that implements scalable, efficient feature merging and/or aggregation.

Examples in the disclosure herein describe a feature generation system that efficiently computes entity-level features based on sets of IDs determined to map to the same underlying entities. Entities include, in some examples, users, or clusters of user personas, views, and/or IDs. Entities can be represented by or associated with canonical IDs. Personas, views, and/or IDs have associated ID-level features that can be computed based on event streams associated with each specific ID. For example, the features can be derived based on a history of a user account's actions (e.g., browsing, purchasing, viewing, clicking, etc.). In some examples, ID-level features reflect traits (e.g., age range, location) that can be evaluated or computed in a state-based manner. For example, the value of a trait depends on the state at a particular time, and it does not take into account a history of values for the specific feature. In some examples, the feature generation system automatically computes and aggregates features corresponding to a pre-defined list of feature types whose semantics allow them to be efficiently aggregated across a set of merged IDs (for example, by using efficient combination or aggregation operators such as sum( ), min( ), max( ), and/or other operators).

In some examples, the feature generation system is part of a predictive trait system, which builds and/or deploys predictive models for events and/or traits associated with members of an audience of interest to a retailer or marketer. The aggregated features and/or aggregate feature values associated with entities and/or canonical IDs can be used to compute predictive traits associated with the respective entities and/or canonical IDs. Computing predictive traits refers to predicting the likelihood of events associated with the entities and/or canonical IDs (e.g., the likelihood of a conversion event such as a purchase event or click event involving a user, the likelihood of a user performing a user action, etc.), predicting the likelihood that a trait or feature of a user will take on a particular value, estimating the likely value of a trait or feature, and/or performing other predictions related to entities and/or canonical IDs. In some examples, predictive traits to be computed are selected via a user interface (UI) at a computing device. The computed predictive trait values can be displayed via the UI at the computing device. By aggregating and/or merging comprehensive historical data across different IDs, personas and/or views corresponding to the same underlying entities (e.g., users), the feature generation system allows for a more robust entity representation and, when integrated in a predictive trait system, for more accurate predictions and/or or classification results.

The example feature generation system accesses merge events from an ID resolution module, the merge events generated when multiple IDs are determined to correspond to one underlying entity. The system includes a canonical ID mapping generator that computes ID-to-canonical ID mappings based on the merge events. In some examples, canonical IDs correspond to aggregate views of users (e.g., comprehensive user behavior histories across logins and/or platforms). The system includes a feature computation module that calculates ID-level features based on historical data. The feature generation system includes a feature aggregation module that accesses the ID-level features and the ID-to-canonical ID mappings, and uses a plurality of operations to aggregate the features across associated IDs for each canonical ID. The feature aggregation module uses one or more aggregations or combination operations appropriate for each respective feature type, as described herein.

ID-level features include at least event-related features and/or trait-related features. Event-related features include count-based features, whose associated aggregation computations use a sum function. Event-related features include rate-based features, whose associated aggregation computations include combining partial information used to compute individual ID-level rate-based feature values. Event-related features include time-since-last event features, whose associated aggregation computations use a min( ) function. Event-related features include time-since-first-event features, in which case the associated aggregation computations use a max( ) function. Event-related features include average-duration-between-events features, in which case the aggregation computations include combining time-since-first event, time-since-last-event, and/or number of events features using appropriate aggregation functions. Event-related features include trend-based features, whose associated aggregation computations use a sum function. Trait-related features are associated with aggregation computations that use priority functions to select among ID-level feature values for the traits.

Rate-based event-related features include a click rate feature based on a number of click events and/or a number of sent actions over a predetermined time period; an open rate feature based on a number of open events and/or a number of sent actions over a predetermined time period; a purchase rate feature based on a number of purchase events and/or a number of site visits over a predetermined time period; and/or a conversion rate feature based on a number of sign-up events and/or a number of views of landing pages over a predetermined time period.

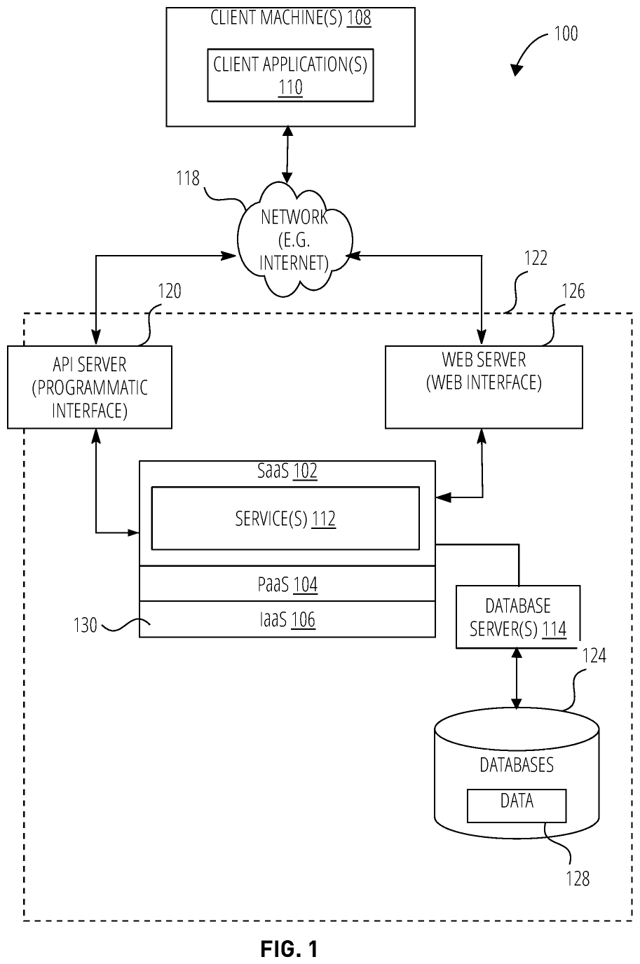

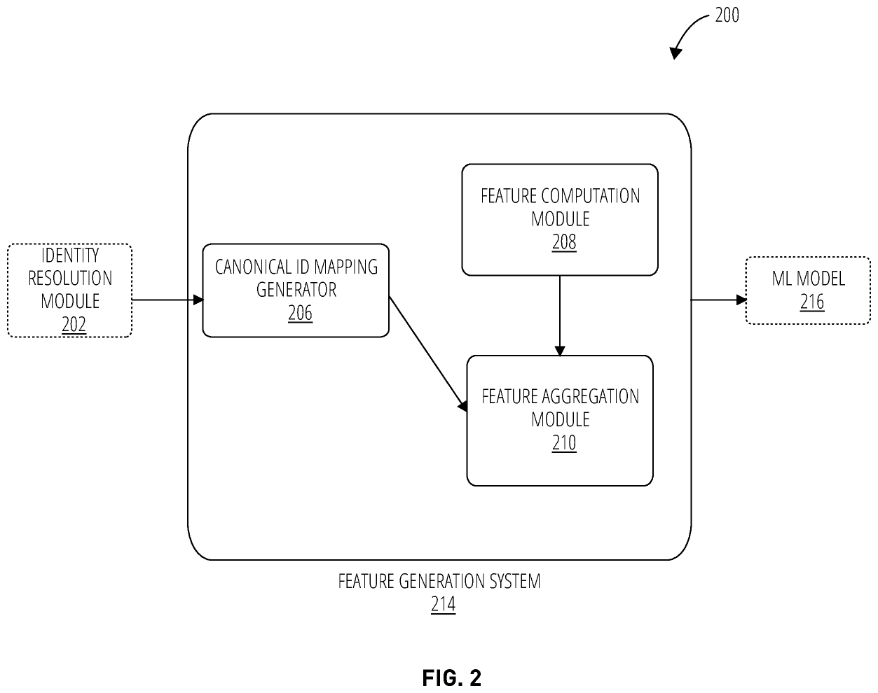

FIG. 1 is a network diagram depicting a system 100 within which various example embodiments may be deployed (such as a feature generation system 214, as illustrated in FIG. 2, which could be part of a predictive trait system 320). A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS, or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, and contact center applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon an infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server applications 112 could also be implemented as standalone software programs. Additionally, although FIG. 1 depicts machines 108 as being coupled to a single networked system 122, it will be readily apparent to one skilled in the art that client machine(s) 108, as well as client applications 110, may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications 112 may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database servers 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data 128 (e.g., via one or more client applications). Various other navigation applications may be provided to supplement the search and browsing applications.

FIG. 2 is a block diagram illustrating a view 200 of a feature generation system 214, according to some examples. In some examples, the feature generation system 214 is part of or used in conjunction with a training workflow 314 or training pipeline 404, as part of a predictive trait system 320. The feature generation system takes input from an identity resolution module 202 and computes a set of aggregated and/or combined features associated with a canonical view or canonical ID corresponding to a target entity. In some examples, such features can be further used by a predictive model, such as ML model 216 (for example, as part of a training workflow 314, training pipeline 404, inference workflow 316 or inference pipeline 406). The feature generation system 214 includes components such as a canonical ID mapping generator 206, a feature computation module 208, and/or a feature aggregation module 210. While the FIG. 2 description of the feature generation system 214 focuses on ID-level feature aggregation or combination in the context of ID resolution, the feature generation system 214 can include components implementing additional functionality related to data processing, feature construction and/or feature selection as described herein.

The feature generation system 214 takes as input data from an identity resolution module 202, which, at a given time, determines that at least two different IDs correspond to the same entity (e.g., to the same user). In some examples, IDs correspond to different views of an entity (e.g., different personas of a user, for example corresponding to different accounts maintained by the same user on different devices and or different social media platforms). Upon determining that two different IDs likely correspond to the same entity, the identity resolution module 202 emits a merge event. In some examples, the canonical ID mapping generator 206 takes as input merge events from the identity resolution module 202 and uses them to compute a set of mappings between IDs and canonical IDs. The mappings are added to a canonical ID table (see below for an example).

For example, upon determining that two IDs A and B for an entity should be merged, the identity resolution module 202 merges ID A into ID B and outputs a first merge event with a schema such as:

Merge_Event(A, B) {
Merged_from: A
Merged_to: B
Timestamp: t₁, where t₁ = <timestamp of the A−>B merge event>
}

Furthermore, upon determining that IDs B and C should be merged, the identity resolution module 202 merges ID B into ID C and outputs a second merge event with a schema such as:

Merge_Event(B, C) {
Merged_from: B
Merged_to: C
Timestamp: t₂, where t₂ = <timestamp of the B−>C merge event>
},
where t₁ < t₂.

Given the above merge events, the canonical ID mapping generator 206 generates a set of (ID, canonical ID) mappings, such as: (A, C), (B,C). (C,C). The generated mappings are added to a canonical ID table, and summarize, at a given time, the IDs merged into a canonical ID (e.g., at time t₂, C is a canonical ID such that A, B and C merged into C).

The feature generation system 214 includes a feature computation module 208. Given a feature definition included in a predetermined set of feature definitions, an ID (e.g., a user's e-mail account associated with a specific e-mail provider, a user's account being used on a specific mobile device, etc.), and/or available data associated with the given ID (e.g., a stream of events such as view/click/purchase events involving a user's account being used on a mobile device), the feature computation module 208 directly computes the value of the feature for the specific ID based on the available data.

In the following, predetermined feature definitions are described merely for example; versions of these feature definitions and additional features can be used as appropriate. The feature definitions described below include event-related features and trait-related features. As mentioned, a feature generation system can use at least one of these feature types, and/or additional feature types. Events can include a set of one or more occurrences or actions (e.g., user actions on a website of a retailer), and/or view events, click events, purchase events, conversion events, and so forth. Event-related features associated with a given ID can be computed based on an event history or event stream associated with the specific ID, such as a history of actions taken by a user on a retailer's website while logged into a specific account on a specific mobile device. Traits can include attributes or characteristics associated with IDs or personas, such as estimated or provided age or age-range, account status (active account, canceled/closed account), account type (e.g., free account, subscription account, premium account), location information associated with an account (city, state, provided street address), and so forth. Trait-related features can be seen as state features: at a given time, the current value of the trait for a specific ID is of interest (e.g., while the use of the history of past values for the same trait is optional).

In some examples, the feature computation module 208 computes count or frequency-based features (e.g., raw count-based features, or transformed count-based features as seen below). Examples of such features, in the context of event streams for specific entities, include the number of ID-level purchase events over a predetermined period (e.g., K days, where K=1/7/14/30/etc.), number of add-to-cart events in a predetermined period, the number of checkout events in a predetermined period, number of clicks on a specific page or button in a predetermined period, and so forth.

In some examples, the feature computation module 208 computes exponentially decaying count features (e.g., an example of transformed count-based features). An exponentially decaying count feature applies an exponential decay function to event counts over time, which allows more recent events to be weighted higher than older events. For example:
ema(event)ₜ=ema(event)ₜ₋₁*(1−decay)+countₜ*decay, where

ema( ) indicates an exponential moving average function, event corresponds to a an event of a specific type, t and t−1 correspond to two successive time points (for example, t corresponds to a current day and t−1 to the previous day), countₜ corresponds to the count associated with the event for day t (in some examples, this count is 0, as many events are relatively sparse), and decay is a configurable value between 0 and 1 that controls the rate of decay. In some examples, the decay value corresponds to a time window with a predetermined length N (for example N days, etc.), with smaller values corresponding to faster decay over time. In some examples, decay=2/(N+1).

In some examples, the feature computation module 208 computes a timeSinceLastEvent and/or a timeSinceFirstEvent feature, for example corresponding to the time since the last or first observed relevant engagement action (e.g., where the time is measured in time units such as seconds/hours/days/weeks, and so forth). Examples of such features include number of days since last login in a user account on a mobile device, number of hours since last browse (or purchase action), and so forth.

In some examples, the feature computation module 208 computes features corresponding based on time periods elapsed between events of same type or differing types (e.g., average duration between purchase events, average duration between events involving a particular user account, etc). For examples, an average duration between events can be estimated as:

$$\frac{timeSinceFirstEvent - timeSinceLastEvent}{numEvents - 1} ,$$

where numEvents>1 (numEvents corresponding to the total number of events (including the first and the last event). In an illustrative example, a total set of events can include 5 purchase events over 50 days, with time since a target event being measured in days, and the last event happening during the present day. The value of the average duration feature would be (50−0)/(5−1)=12.5 days. If numEvents is 1, the value of the average duration between events can be set to null or another special purpose value.

In some examples, the feature computation module 208 computes features based on summary statistics of a set of observed values for a specific event, for example, sum of purchase amounts in the last K days (e.g., K=15 or K=30), average order value over the last K days, total number of logins in a specific account over the past K days, average amount of time spent on site per visit, and so forth.

In some examples, the feature computation module 208 computes trend-based features, such as a difference between a short-term average of event counts and long-term average of events counts (e.g., a purchase event, a browse action, etc.) In some examples, short term and long-term periods are predetermined as corresponding to a set number of time units (e.g., hours/days/weeks, etc.). For example, a short-term average could be computed over 30 days, while a long-term average could be computed over 180 days. In some examples, the average computation uses a moving average (such as an exponential moving average). Additional trend-based features for given event types include: a difference between M-day and N-day moving averages of time on site per visit (for example, capturing changes in engagement), a difference or percent change between M-day and N-day averages of time between sessions, and so forth. The specific time units and time frames corresponding to the short-term and long-term periods can be pre-specified or can be automatically tuned for specific metrics.

In some examples, the feature computation module 208 computes features based on a rate (e.g., an open rate, click rate, purchase rate, other conversion rates, etc.). Such features correspond to (or be derived based on) known events or system events common across a set of customers (e.g., marketers) of the overall system, for which the system has a usable semantic model or semantic understanding. For example, rate-type features (e.g., click rate, open rate, purchase rate, conversion rate, and so forth) can be computed over a predetermined time period, given a type of target event (e.g., a click on a marketing e-mail) and a type of reference event (e.g., a send action for a marketing e-mail). For example, the feature computation module 208 can compute a feature corresponding to a click rate for marketing e-mails over a 30 day period as the average between the number of clicks on marketing e-mails sent in the past 30 days and the number of marketing e-mails sent in the past 30 days. Other such features include purchase rate (ratio of number of purchases to the number of site visits), conversion rate (ratio of number of sign-ups to number of views of landing pages), and so forth.

In some examples, the feature computation module 208 computes trait-based features. As mentioned above, traits are state-based variables, corresponding to characteristics or attributes of an ID.

Given a set of distinct IDs merged into a canonical ID (e.g., based on the output of an ID resolution module), the feature aggregation module 210 aggregates or combines feature values for ID-level features across the set of previously distinct IDs, as discussed herein.

Given a particular feature associated with multiple IDs, the feature aggregation module 210 combines ID-level feature values using various aggregation mechanisms in order to compute an aggregated feature value associated with a canonical ID at a particular time. In some examples, the feature generation system 214, for example at the feature aggregation module 210, has access to a set of features (e.g., a schema) common to all IDs of interest (e.g., all personas or views of interest for a user have the same set of associated features). In some examples, the feature generation system 214, for example at the feature aggregation module 210, has access to different features for different IDs that can be merged, and uses a schema mapping and/or schema reconciliation set of operations to generate a unified set of features across the IDs of interest. Merely for convenience, the following focuses on the example of merged IDs having the same set of features, with the feature aggregation module 210 operating to aggregate and/or combine feature values for a canonical ID into which multiple other IDs have been merged.

In some examples, the feature aggregation module 210 directly uses final ID-level feature values as part of its aggregation computation, using aggregation functions such as sum( ), max( ), min( ) etc. In some examples, the feature aggregation module 210 uses, as part of its aggregation computation, partial information (e.g., partial inputs) previously used to compute ID-level feature values (as described herein). In such examples, the computation of feature values at the level of the canonical ID amounts to a partial recalculation computation, using previously computed partial information (e.g., previously computed quantities or counts). In some examples, the feature aggregation module 210 performs state-based aggregation (e.g., for trait-based features, as described herein). In the case of features with a temporal component, the feature generation system 214 captures the continuous history of an entity (e.g., a user) across different IDs that have been determined to correspond to the same entity.

The feature aggregation module 210 takes as input the canonical IDs table (canonical ID table) that maps merged IDs to one or more final canonical IDs. Given a canonical ID for a target entity and a set of distinct IDs merged into the canonical ID, the feature aggregation module 210 accesses computed feature values for each of the merged IDs, or, if necessary, precomputed partial quantities or counts used in the ID-level feature value computation. The feature aggregation module 210 applies an appropriate aggregation computation to combine the feature values across the IDs that map to a canonical ID (see below for details), and outputs a single aggregated feature value per canonical ID that incorporates the data across associated IDs.

Count or frequency-based features (e.g., such as number of purchases in the last 30 days) are combined using the sum( ) aggregation function (e.g., the combined feature value for the canonical ID is the sum of the ID-level feature values corresponding to the set of IDs merged into the canonical ID. Exponentially decaying count-based features, sum/average-based features and trend-based features are also aggregated using a sum( ) aggregation function.

In some examples, a timeSinceLastEvent feature value for the canonical ID corresponding to a target entity is computed as the minimum of the individual timeSinceLastEvent feature values for the corresponding merged IDs (e.g., min(f(A), f(B)), where A and B are distinct IDs and f(A) and f(B) correspond to the values of the target feature for the two IDs). A timeSinceFirstEvent feature value is computed as the maximum of the individual timeSinceFirstEvent feature values for the corresponding merged IDs (e.g., max(f(A), f(B)).

In some examples, features such an average duration between events of a certain type (or differing types), can be aggregated as follows:

$$\frac{combinedTimeSinceFirstEvent - combinedTimeSinceLastEvent}{combinedNumEvents - 1} ,$$

where combinedTimeSinceFirstEvent, combinedTimeSinceLastEvent, and combinedNumEvents are the features timeSinceFirstEvent, time SinceLastEvent and numEvents features aggregated as described above (e.g., using, respectively, a max( ) aggregation function, a min( ) aggregation function, and a sum( ) aggregation function). As above, if the combinedNumEvents is 1, the value of the feature can be set to null or another special value.

In some examples, rate-based features can be aggregated based on combining partial information used to compute individual ID-level rate-based feature values. For example, in the case of a feature corresponding to a click rate for marketing e-mails over a K days period (e.g., K=15/30/60/90/etc.), the combined canonical ID-level feature value can be computed as follows:

$${combinedClickRate}_{K} = \frac{{combinedNumClickActions}_{K}}{{combinedNumSendActions}_{K}} ,$$

where combinedNumClick ActionsK, combined NumSend ActionsK are computed using aggregate functions appropriate for frequency-based features, as described above (for example, using the sum( ) aggregation function).

In some examples, a value of a trait-based feature for a canonical ID is computed using a priority function imposed over ID-level trait-based feature values for the distinct IDs merged into the canonical ID. For example, the priority function could favor the most recent merged ID (and its corresponding trait-based feature value). In some examples, the identity resolution module 202 could output confidence scores associated with the merge events and the feature aggregation module 210 could prioritize a recently merged ID (e.g., within the past K hours or days) with the highest associated confidence score. In some examples, the feature aggregation module 210 can prioritize a directly received or inferred value for the canonical ID, regardless of the values associated with merged IDs.

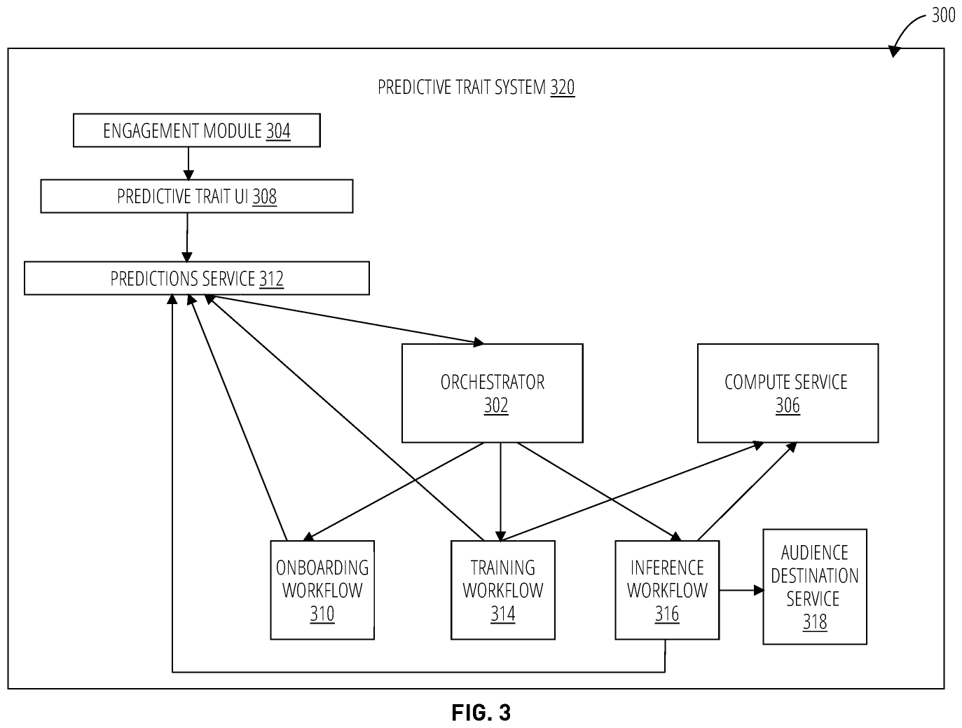

FIG. 3 is a block diagram illustrating a view of a predictive trait system 320 that includes a framework for creating, training, and/or deploying models (e.g., machine learning models) that predict the likelihood of a future event (e.g., involving a user action, a predefined conversion event, etc.) or user trait value, according to some examples. A prediction model for an event, action or trait computes the likelihood of the event, action, or a trait value within (or over) a future time period (e.g., the next 30 days). In the following description, the terms “predictive traits” or “traits” are used to refer to events (e.g., involving user actions) and/or user traits (e.g., age, location, and so forth).

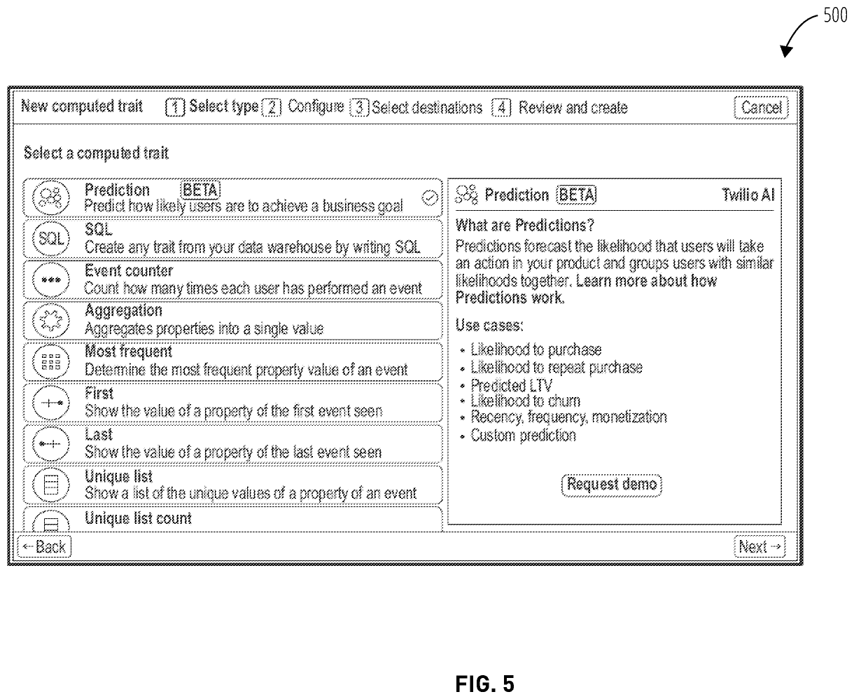

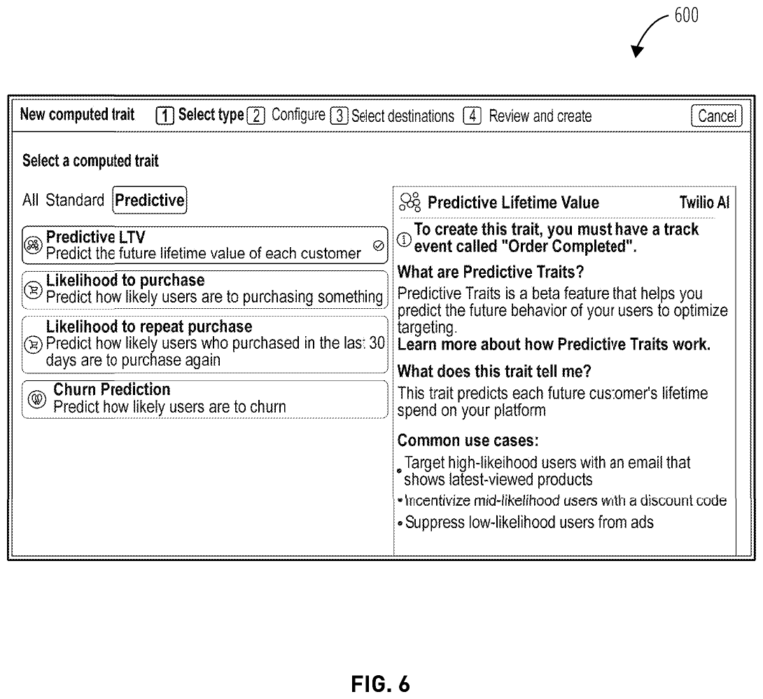

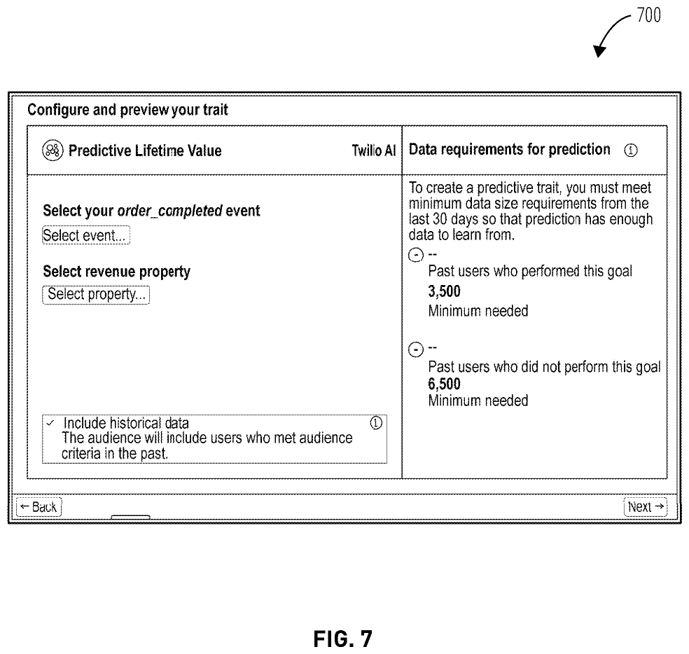

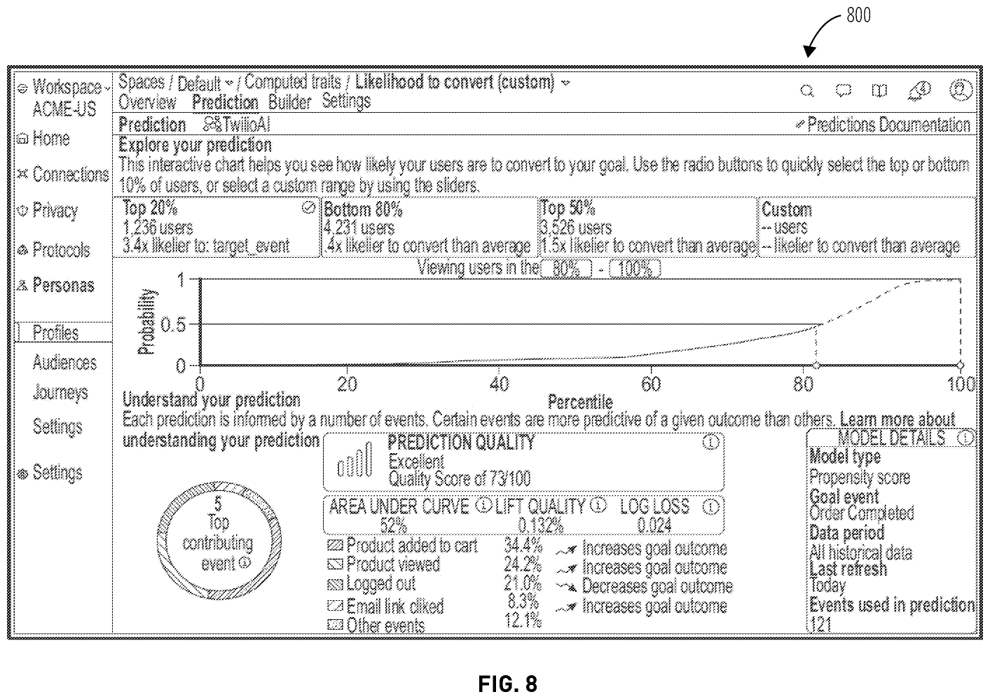

In some examples, predictive trait system 320 includes an engagement module 304 that allows a user (e.g., a marketer, a business, a person, etc.) to start engaging with the system (for an example of an initial engagement, see FIG. 5). In some examples, a user (e.g., a marketer) can select a prediction user-selectable UI (UI) element, indicating that the user is interested in using a predictive trait model. The predictive trait system 320 includes a predictive trait UI 308 with user-selectable interface elements that, upon selection by the user, allow the user to choose one or more of a set of traits for which to compute a prediction (e.g., predictive traits). In some examples, predictive traits include customer lifetime value (LTV), purchase actions (e.g., for specific objects or types of purchases), repeating purchases, churn, and more (for further details, see FIG. 6, FIG. 7, or FIG. 8). In some examples, a user (e.g., marketer) selects one or more UI elements of the predictive trait UI 308 in order to configure a trait prediction. For example, the user (e.g., marketer) can configure an already selected predictive LTV trait by selecting a order_completed event and a revenue property (see FIG. 7 for details).

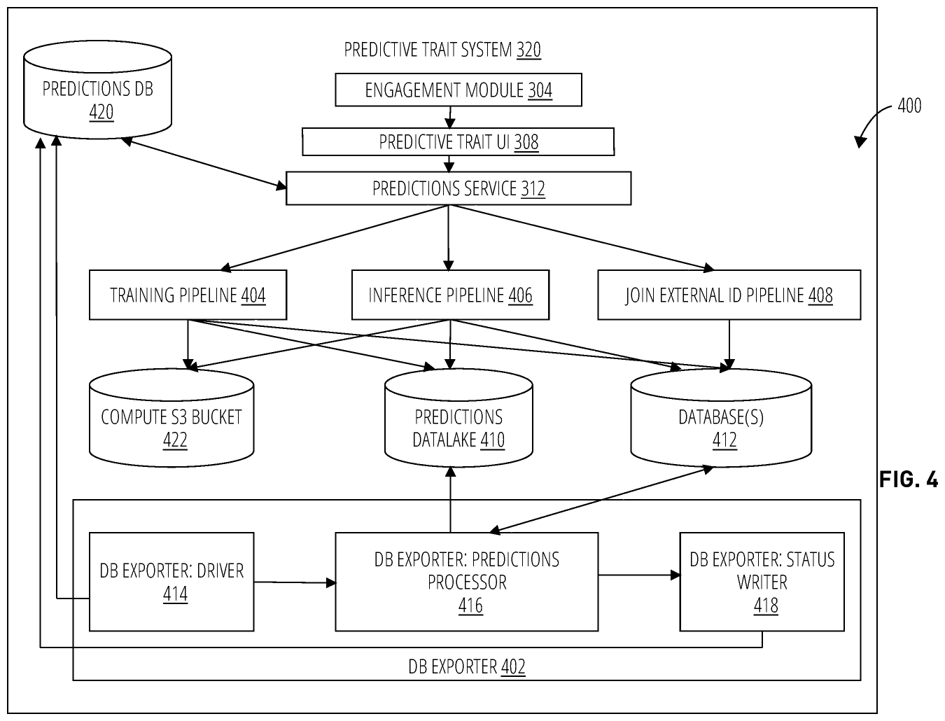

Once a trait has been selected and configured by a user via the predictive trait UI 308, the predictive trait UI 308 executes a call (e.g., an API call) or a series of calls to the predictions service 312, which is responsible for running pipelines for training trait-specific models and performing inference using trained trait-specific models (see FIG. 4 below). The predictions service 312 communicates with an orchestrator 302 (e.g., a component of the predictive trait system 320, for instance a Conductor orchestration engine managed by Orkes, or an orchestration engine within any other workflow orchestration platform). The orchestrator 302 schedules workflows such as onboarding workflow 310, a training workflow 314, or an inference workflow 316. The workflows run a number of processes related to the training, evaluation, deployment of models for predicting selected traits.

In some examples, the onboarding workflow 310 starts subsequent to the detection, by the orchestrator 302, of a communication from the predictions service 312 (e.g., comprising information about a selected and/or configured trait for which to build, evaluate and deploy a prediction model). In some examples, the onboarding workflow 310 starts upon the predictive trait system 320 detecting that a user (e.g., marketer) requests access to the predictive trait UI or predictive trait functionality (e.g., by engaging with the predictive trait UI 308 as described above). In some examples, the onboarding workflow creates a user (or customer) workspace (e.g., to enable database exports of needed customer data, as detailed in the FIG. 4 discussion). In some examples, the onboarding workflow 310 enables a feature flag that indicates the user has access to the predictive trait (or trait prediction, etc.) functionality from this moment forward. In some examples, the onboarding workflow 310 communicates with the predictions service 312 in order to transmit the user (e.g., customer) namespace information.

In some examples, a training workflow 314 runs a training process. The training workflow 314 checks whether it has access to a set of necessary data (or database exports), such as necessary customer data for a given period, for example. The training workflow 314 creates a training set (e.g., a training audience) and runs a training pipeline 404 (see FIG. 4) for a model (e.g., a machine learning model) for predicting a selected, customized trait (e.g., predicting the likelihood of a future action, conversion event, etc.). The training workflow 314 creates a training set (e.g., training audience) by using a compute service 306, and stores the data about the members of the training audience in a compute S3 bucket 422 (see FIG. 4). The training workflow 314 is responsible for retraining a trained model with fresh data (e.g., periodically, or triggered by a drop in assessed performance of the model or based on other explicit triggering events). In some examples, the predictive trait system 320 computes and monitors periodically a comprehensive set of metrics in order to ensure the health of the models in production (e.g., a Population Stability Index, a Characteristics Stability Index, where such measures track various stability indicators for model performance over time and over populations or specific characteristics). In some examples, a set of criteria and operations/decision logic is implemented by the predictive trait system 320 to trigger model retraining, fresh data collection, and other steps in order to improve the health of the deployed models.

In some examples, an inference workflow 316 runs an inference process. The inference workflow 316 creates an evaluation or test set (e.g., an inference audience) and runs an inference pipeline 406 and a join external ID pipeline 408 (see FIG. 4 for details). The inference pipeline 406 retrieves a trained prediction model for a trait and computes prediction results for the trait of interest over the evaluation or test set (e.g., computes a prediction for a trait corresponding to a predicted action by each customer in an inference audience). Once a trained trait-specific prediction model computes trait prediction scores for each user in the test set (e.g., inference audience), the predictive trait system 320 sends the computed scores to destinations within an audience destination service (e.g., in order to be used in building of audiences), or add them to customer journeys. Therefore, the trait prediction results are synchronized with user profiles and specific destinations within an audience destination service 318. In some examples, additional post-inference outputs (e.g., percentiles, stats, other model explainability quantities, null trait values for non-active users) are computed, for example by the join external ID pipeline 408 (see FIG. 4). Such post-inference outputs are also uploaded or synchronized, by the inference workflow 316 via a sync workflow with audience destination service 318.

Predictive trait systems such as predictive trait system 320 can be of use to many types of marketers, businesses, as well as to data scientists. For example, in addition to tracking and profiling customers or users based on past behavior, marketers and businesses are interested in predicting future user traits or behavior (e.g., a user's likelihood to convert), which can help with communication frequency, pricing offers and message personalization (fine-tuning the content of an ad, email or website), helping decide which users to include or exclude in marketing or e-mail campaigns, and more. Allowing the marketers to easily create multivariate, intelligent predictive traits, and perform trait prediction on-demand would therefore be helpful in multiple use cases.

Computing selected traits is particularly useful for difficult to measure outcomes (e.g., activation, retention, engagement, or long-term value journeys). Additionally, predicting user behavior (or conversion events, etc.) has good performance and/or robustness in the case of products or platforms with a large number of users (e.g., 100,000 average monthly users or more). The system can use such on-demand, trait specific prediction models in order to build easily build different types of audiences or cohorts (e.g., predict at-risk or VIP customers, rather than reverse engineering behaviors), create better campaigns based on what a user will do in the future rather than their past behavior, create predictive models without a need for specialized additional data science expertise, understand how the model was built, why it performs as it does, or build campaigns with lower customer acquisition costs (CAC) and higher conversion rates.

Additionally, the system can use such easily trainable and customizable models to focus on more complex, or time-intensive business problems, build audiences faster, directly use machine learning to improve targeting specific users or audiences rather than guessing as to which customers may convert, track how the likelihood of a user taking a certain action (e.g., propensity to take an action, propensity scores, etc.) may change for each user over time, or offload audience creation to other teams (e.g., marketing) in order to focus on additional initiatives.

FIG. 4 is a block diagram illustrating a view of a predictive trait system 320 that includes a framework for creating, training, and/or deploying predictive trait models (e.g., machine learning (ML) models), according to some examples. Such models compute or predict the likelihood of a future event (e.g., predefined conversion event such as a user purchase or a user click event, or other events involving one or more user actions), the likelihood of a user trait taking on a predefined value, the expected value of a user trait, and other types of predictive traits.

### Trait-Specific ML Models

### Feature Set and Development Set Construction

In some examples, the models (e.g., ML models) use any relevant type of data for constructing/augmenting a training set and/or generating features. For examples, features include features computed based on event streams, timestamp-related features, features derived from user profiles, attributes or behaviors, raw features, transformed or aggregated features with respect to some aggregation function (as discussed herein). In some examples, feature engineering and/or feature set construction can be implemented by the predictive trait system 320 as a combination of a scheduled daily component and aggregation at training time for computation cost savings. Event stream-based transformations can be expanded to include timestamp information (day of the week, week of the year, month of the year) or activity intervals. In some examples, user profile or user trait data is processed to remove personal identification information (PII). In some examples, categorical data embedding techniques are used to derive embeddings from the raw feature data.

In some examples, the feature generation process described above is implemented by a feature generation system 214, as described in FIG. 2. When multiple personas, views, or IDs for an entity (e.g., a user) are found to be associated with a single canonical ID corresponding to the entity (e.g., user), the feature generation system 214 aggregates feature values for each relevant feature and computes aggregate feature values associated with the canonical ID and/or entity or user. The predictive trait system 320 can then execute predictions or computations at the level of canonical IDs or entities. For example, the predictive trait system 320 can predict the likelihood of a future conversion event (such as a click event or purchase event) associated with a canonical ID and/or a group of merged personas/views/IDs.

In some examples, appropriate feature selection or pruning (e.g., selecting top K features by correlation coefficient, using dimensionality reduction (e.g., via PCA) to decrease the effect of highly correlated features), automatic identification of features likely to contribute to overfitting, and other feature set analysis and transformation steps are performed by the predictive trait system 320 (e.g., as part of the training pipeline 404 described below). The predictive trait system 320 and the models described below can remain agnostic to any specific marketing domain knowledge. Alternatively, the predictive trait system 320 and the models described below can use specific marketing domain knowledge, for example as specified by a system customer (e.g., marketer) with domain expertise, or by a developer.

In some examples, the data used to build a trait-specific ML model encompasses a time component, and therefore the predictive trait system 320 must define and enforce minimum history requirements, for example with respect to the various event streams (e.g., event streams used to build features, etc.) In some examples, the minimum required history for events related to features is based on the set of one or more feature window sizes used during a featurization process (e.g., constructing the feature set). In some examples, the predictive trait system 320 can use inclusion criteria for users, in order to ensure that both features and target variables can be computed (e.g., based on automatically tracked measures of user activity, by including only users whose activity meets a set of predefined thresholds). In some examples, a cold start strategy can be used to include users with less activity or no activity.

In some examples, the predictive trait system 320 can train one trait-specific model for users that have performed a target action (or were connected to a target event) before and one model for users that have not performed the target action/even before and combine them. In some examples, each of the respective user subpopulations can be required to meet predefined thresholds (e.g., related to subpopulation size, activity levels per user, etc.) in order to guarantee a model can be trained.

In some examples, when constructing the training/evaluation set and deriving a label for each example in the training/set, the predictive trait system 320 can use simple binary labels derived from the occurrence of an event during a target window of time. In some examples, the predictive trait system 320 can embed time information encoded in the event in the label creation process. In some examples, the system can implement a cost function weighting schema based on subgroups. Such subgroups can include, for example, target events corresponding to repeat purchases, new purchases, no purchases, and so forth.

In some examples, a predictive trait system 320 can use information (e.g., criteria, characteristics) provided by the user (e.g., marketer) in order to select a subpopulation of interest for model training. In some examples, additional criteria and logic can be implemented by the predictive trait system 320 to ensure congruence between model training and model inference phases.

In some examples, “training set” is understood in the context of ML model development, where a development set is selected and properly split into train/validation/test sets (therefore the training set ca refer to a “train/validation” set, and a test set can refer to “test/evaluation” or “test/assessment” set). In some examples, properly splitting the development set takes into account temporal dependencies (e.g., corresponding to the time series nature of the event streams, or the tracked user behaviors).

### Model Evaluation Considerations

In some examples, models trained by the predictive trait system 320 can be compared against a relevant baseline, using traditional evaluation metrics (e.g., normalized cross entropy, hazard ration, ROC-AUC, PR-AUC, etc.). In some examples, other evaluation metrics, such as some especially relevant for business lift, can be used. In some examples, a baseline can be a univariate scaled score based on most correlated feature/event (extreme feature selection). In some examples, a model will be deployed if its performance (as given by 1 single metric, e.g., L-quality) is at least as good as the baseline performance and/or a previous trained model.

In some examples, evaluation metrics can be computed separately for choice subpopulations (e.g., users new to target event or taking an action for the first time, “lapsed Xers” such as users who previously took an action but no longer do so, etc.). In some examples, a functional form of scores distribution is computed as part of the evaluation metrics suite. In some examples, the size of predicted groups, the correlation of predictions for choice user subpopulations during a feature time window (e.g., “Xers” vs “no-Xers,” where X is a user action or target event of interest) is used as part of evaluating whether the performance of a trained model is superior to that of a baseline model. In some examples, a “replay” feature is implemented to show a customer what kind of benefit trait prediction scores for a selected trait would have provided over time (e.g., especially if a long event stream collection for the target event/trait is available).

### Predictions Service

In some examples, a predictions service 312 of a predictive trait system 320 will run a training pipeline 404 (e.g., created by a training workflow 314). In some examples, the training pipeline 404 retrieves relevant customer data (e.g., user profile data for training set members or training audience members, such as the one constructed by a training workflow 314), from one or more databases or datalakes (e.g., predictions datalake 410, database(s) 412, etc). In some examples, data about membership in an audience (e.g., audience membership data) is read or accessed, e.g., from a compute S3 bucket 422 (where it had been previously stored, for example by the compute service 306). In some examples, user profile data or audience membership data is stored in a different configuration of datalakes, databases, cloud storage, etc. In some examples, the training pipeline assembles the relevant data for each member of the training set (training audience) by accessing and combining user profile data and audience membership data. In some examples, the training pipeline 404 reads lean events from the predictions datalake 410. In some examples the training pipeline 404 reads lifetime value (LTV) event properties, and the latest version of merge tables, from one or more database(s) 412.

Once a training pipeline 404 retrieved the relevant customer data for the trait (or event) of interest and the training test (training audience) of interest, the training pipeline 404 trains a new model (e.g., ML model) corresponding to the trait of interest (e.g., a predictive LTV model, a model for predicting likelihood to purchase, etc.). In some examples, a trained model for a specific trait of interest is evaluated by comparing it with a baseline model (e.g., a marketer provided model, a model constructed with marketer input, etc.). If the predictive trait system 320 automatically assesses that the trained model meets a number of predetermined performance-related thresholds (e.g., accuracy on a held-out set, performance superior to a baseline model on a held-out set, etc.), the trained model is then used for inference (see below).

In some examples, the predictions service 312 runs an inference pipeline 406 (e.g., as part of the inference workflow 316). In some examples, running an inference pipeline 406 comprises retrieving a trained trait-specific model and running the model for each member of a test set (e.g., inference audience). In some examples, the test set (e.g., inference audience) is created as part of the inference workflow 316, for example by using a compute service 306. In some examples, the test set (e.g., inference audience) is stored in storage (e.g., cloud storage) for the respective compute service (e.g., cloud compute S3 bucket 422), and is accessed (read) by the inference pipeline. In order to run a trained model on each member of an inference audience, inference pipeline 406 is assemble the relevant data for each inference audience member (e.g., from predictions datalake 410, databases 124, etc.). In some examples, inference pipeline 406 reads lean events (e.g., from predictions datalake 410) and event properties (e.g., for lifetime value) as well as the latest version of merge tables (e.g., from databases 124).

Once the inference pipeline 406 finished running the model, the predictions service 312 runs a join external ID pipeline 408 408. In some examples, the join external ID pipeline 408 joins the results of the inference pipeline (e.g., computed prediction(s) for each member of the inference audience) with external ID tables (e.g., as required by an audience destination service 318). In some examples, the external id tables are from storage such as from one or more database(s) 412, etc. In some examples, the join external ID pipeline 408 can compute post-inference outputs (e.g., percentiles, stats, model explainability-related quantities, etc.). Additionally, the join external ID pipeline 408 indicates or marks null trait values for users with low or no activity (non-active users), according to one or more activity-related predetermined thresholds.

In some examples, the inference pipeline 406 and join external ID pipeline 408 can run as part of an inference workflow 316 (see above). The inference workflow 316 can upload predictions (e.g., results of the inference pipeline 406) to user profiles and destination within an audience destination service 318, and therefore update user profiles.

In some examples, the predictive trait system 320 includes a database (DB) exporter 402, which in turn includes a DB exporter: driver 414, a DB exporter: predictions processor 416 and a DB exporter: status writer 418. The DB exporter: driver 414 triggers an export pipeline (e.g., exporting data from database(s) 412) for a given customer namespace (e.g., a current customer namespace). The export pipeline runs on a schedule (e.g., every 12/24/48 hours, etc.). In some examples, the DB exporter 402 (e.g., via the DB exporter: driver 414) queries stored customer namespace data (e.g, stored in a predictions DB 420), which can involve reading their latest timestamp. In some examples, the predictive trait system 320 (e.g., via the DB exporter 402) records the creation of a new job. The DB exporter: predictions processor 416 queries customer events and traits from databases 124 incrementally, by date (only new events are processed). In some examples, the DB exporter: predictions processor 416 exports data to a predictions datalake 410. In some examples, the DB exporter: status writer 418 completes the data export process, upserting the latest timestamp for the given (e.g., current) customer namespace.

In some examples, the storage used by the predictive trait system 320, including one or more of at least a predictions DB 420, a predictions datalake 410 and/or database(s) 412, includes different types of storage (e.g. Postgres RDS database for the predictions DB 420, an Apache Iceberg (or other solutions for large analytic tables) for predictions datalake 410, BigQuery for database(s) 412, and so on). In some examples, the predictions DB 420 contains customer namespace information, predictive traits, as well as pipeline and data export states. This information can be retrieved and updated or augmented by various workflows and/or pipelines as described above. In some examples, one or more of the pipelines in the predictive trait system 320 can be implemented using a cloud-based machine learning service such as Amazon SageMaker or a compute service such as AWS Lambda.

In some examples, the components and modules of the predictive trait system 320, as described below (or in conjunction with FIG. 3) enable large-scale deployment of models for a broad base of customers (e.g., hundreds of models for thousands of customers).

FIG. 5 is a diagram illustrating a view 500 of a UI for predictive trait system 320, according to some examples. As part of an onboarding phase, a system user (e.g., marketer) can select one or more user-selectable interface elements in order to choose a “prediction” mode and/or one of a set of predictive traits of interest (e.g., see FIG. 6 for further details). The user can request a demo, or fill out a form as part of an onboarding phase.

In some examples, the predictive trait system 320 offers a set of baseline or core predictive traits, such as likelihood to purchase (e.g., corresponding to a likelihood of a user purchase event or user purchase action), likelihood to repeat purchase, predictive LTV, likelihood, or propensity to churn, and other core traits. In some examples, the predictive trait system 320 can allow the system user to create and/or customize a custom prediction goal or custom trait.

FIG. 6 is a diagram illustrating a view 600 of a predictive trait selection within the UI for predictive trait system 320, according to some examples. An example predictive trait (e.g, an example of a computed trait) is Predicted LTV, which automatically predicts the future lifetime value of a user (e.g., customer of a business) and assigns to the user the predicted trait value computed by trait-specific model. In some examples, LTV predictions (e.g., dollar amount values, rounded with respective to an example rounding scheme such as nearest dollar or 10 dollars) computed by a LTV-specific trained model can be stored in association with the profile of each user for which a prediction was made. In some examples, the raw LTV number is separated into percentile cohorts, including LTV, and LTV_percentile. LTV corresponds to an estimated dollar amount likely spent by each user (e.g, customer of a business) on a platform over their lifetime. In some examples, a model for predicting LTV uses features such as average order value, purchase frequency, and/or user lifespan. In some examples, a user's predicted LTV will change on a weekly basis based on changes in site- or platform-level user behavior, which can result in the predicted LTV value being re-estimated.

Use cases for the predicted LTV trait include campaign optimization, audience optimization, audience discovery, prebuilt traits, audiences, data-driven customer profiling, customer journey optimization customer lifetime value modeling, digital marketing optimization, reducing churn and increasing retention. In some examples, other predictive traits can be used for one or more of the listed use cases.

FIG. 7 is a diagram illustrating a view 700 of a predictive trait configuration within a UI for predictive trait system 320. For example, as seen in FIG. 6, a user (e.g., marketer) can configure LTV as a predictive trait (e.g., “Predictive LTV”) within the predictive trait UI 308 of the predictive trait system 320. In some examples, the user selects an event corresponding to an “order_completed” event, as well as a revenue property. In some examples, a trait can only be created and/or fully configured once. The trait can be re-created if deleted. Multiple versions of a trait are able to be created and/or configured.

In some examples, a trait can be created if certain thresholds are met (e.g., data size requirements for a predetermined period of time, such 30 or 60 days, are met). Such thresholds ensure that the model has a large enough training set. Additional criteria can include a minimum number of active users that are historically active, or active over the predetermined past period of time, and so on. In some examples, error states indicating the criteria that were not met, or other reasons for the inability to create a trait, are displayed to the user as part of the UI for the predictive trait system 320.

FIG. 8 is a diagram illustrating a visualization 800 of data related to trait prediction results in a predictive trait system 320, according to some examples. In some examples, a user (e.g., marketer) can select user-selectable UI elements to choose a percentile to build a cohort (top K % users ranked by the probability that they will undertake the desired action, or convert to the marketer goal expressed as a target_event). In some examples, the predictive trait system 320 includes additional visualizations, such as for example a visualization of historical trait values, for example based on various aggregation functions or statistics computed over the population of users for which historical trait-related data is available, etc. In some examples, the UI of the predictive trait system 320 includes a visualization of historical trait values for only certain users of interest.

In some examples, the UI for the predictive trait system 320 can include a visualization of the change in the propensity scores (e.g., trait prediction values) for one or more users (e.g., people in the set a customer is interested in). A user's propensity score may change periodically (e.g., weekly) based on the actions they take (e.g., in interacting with one or more tracked websites). A visualization displayed within a UI for the predictive trait system 320 can show the overall propensity of a set of people changing periodically (e.g., on a weekly basis): an average score for a user population (e.g., the average score varying over time), or track an collective measure of propensity scores (e.g., the propensity to purchase over time) as they change periodically (e.g., from week to week), based on new trait prediction values (propensity scores) being computed. In some examples, percentile-level changes (e.g., changes in the top 10% cohort, bottom 10%, etc.) may be visualized. In some examples, visualizations may use a min-max candle view.

In some examples, the UI for a predictive trait system 320 includes selected information about trait usage (particular steps in audience construction, journeys, etc.), trait growth and more. The UI can include a visualization of data pertaining to the training and evaluation of the trait-specific model (feature information, feature weights, a score indicating prediction quality and other information pertaining to explainable AI-type functions or modules). The UI can include data collection guidelines (either embedded in the UI or available in linked documentation) for customers, in order to improve quality and impact of likelihood models.

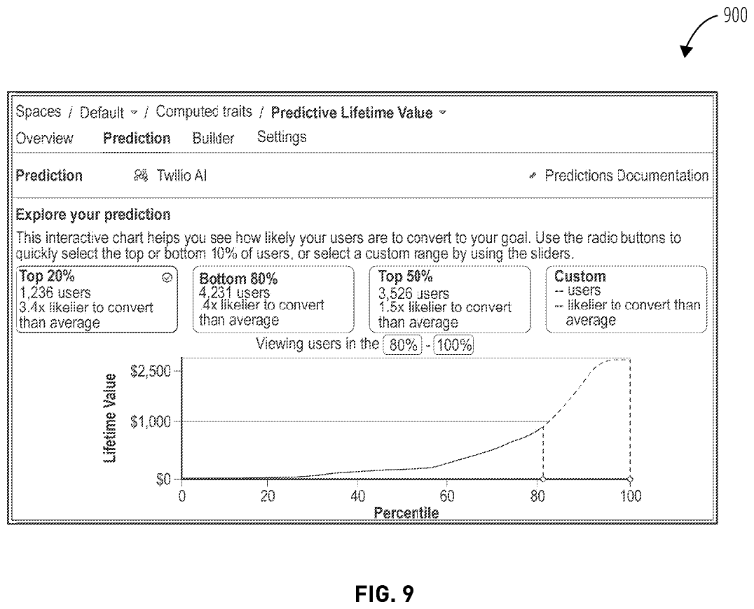

FIG. 9 is a diagram illustrating a visualization 900 of data related to trait prediction results in a predictive trait system, according to some examples. In some examples, as seen above in FIG. 6 and FIG. 7, the trait is Predictive LTV. Upon obtaining trait prediction results for a selected and configured predictive trait, the predictive trait system 320 displays a visualization of user percentile cohorts (e.g., top X %, where X=10, 20, etc.) based on the prediction scores computed for the users of interest. In some examples, the predictive trait system 320 displays information about the trait-specific model. In some examples, once the trait (e.g., Predictive LTV) has been computed, a user of the predictive trait system 320 can use it to build an audience, add to a journey, or send to a downstream destination.

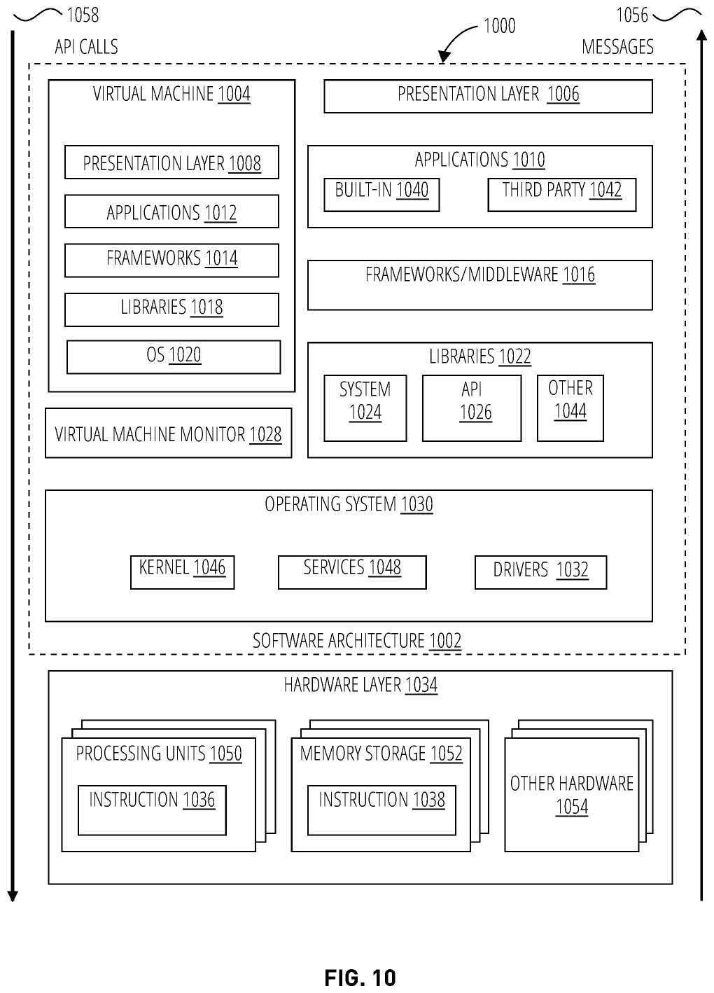

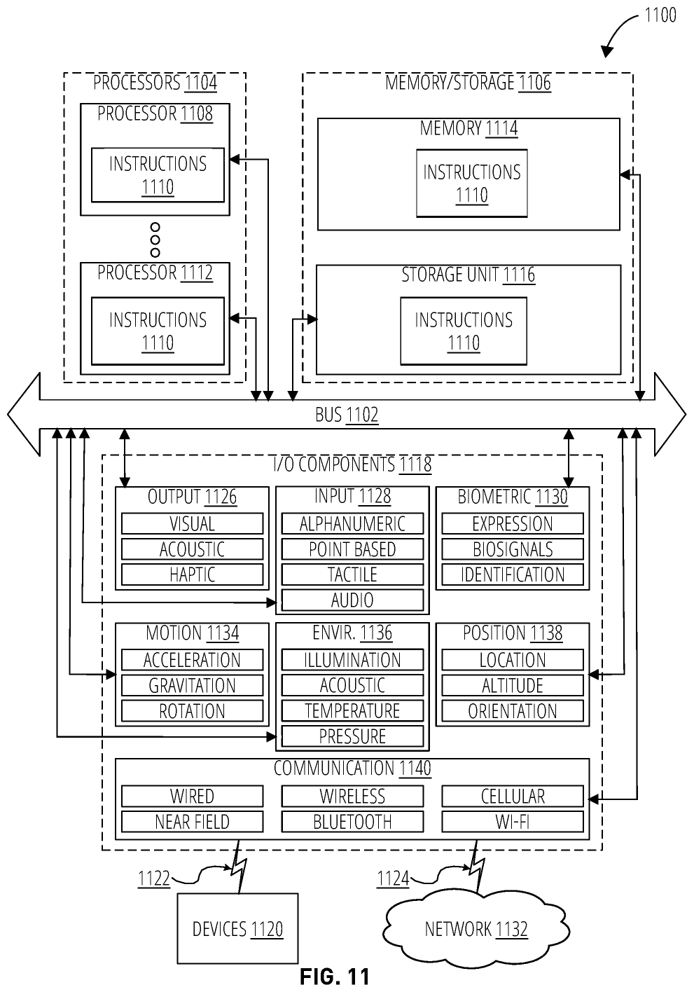

FIG. 10 is a block diagram illustrating an example of a software architecture 1002 that may be installed on a machine, according to some example embodiments. FIG. 10 is merely a non-limiting example of software architecture, and it will be appreciated that many other architectures may be implemented to facilitate the functionality described herein. The software architecture 602 may be executing on hardware such as a machine 1100 of FIG. 11 that includes, among other things, processors 1104, memory/storage 1106, and input/output (I/O) components 1118. A representative hardware layer 1034 is illustrated and can represent, for example, the machine 1100 of FIG. 11. The representative hardware layer 1034 comprises one or more processing units 1050 having associated executable instructions 603. The executable instructions 603 represent the executable instructions of the software architecture 1002. The hardware layer 1034 also includes memory or storage 1052, which also have the executable instructions 1036. The hardware layer 1034 may also comprise other hardware 1054, which represents any other hardware of the hardware layer 1034, such as the other hardware illustrated as part of the machine 1100.

In the example architecture of FIG. 10, the software architecture 1002 may be conceptualized as a stack of layers, where each layer provides particular functionality. For example, the software architecture 1002 may include layers such as an operating system 1030, libraries 1018, frameworks/middleware 1016, applications 1010, and a presentation layer 1008. Operationally, the applications 1010 or other components within the layers may invoke API calls 1058 through the software stack and receive a response, returned values, and so forth (illustrated as messages 1056) in response to the API calls 1058. The layers illustrated are representative in nature, and not all software architectures have all layers. For example, some mobile or special-purpose operating systems may not provide a frameworks/middleware 1016 layer, while others may provide such a layer. Other software architectures may include additional or different layers.

The operating system 1030 may manage hardware resources and provide common services. The operating system 1030 may include, for example, a kernel 1046, services 1048, and drivers 1032. The kernel 1046 may act as an abstraction layer between the hardware and the other software layers. For example, the kernel 1046 may be responsible for memory management, processor management (e.g., scheduling), component management, networking, security settings, and so on. The services 1048 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1018 may provide a common infrastructure that may be utilized by the applications 1010 and/or other components and/or layers. The libraries 1018 typically provide functionality that allows other software modules to perform tasks in an easier fashion than by interfacing directly with the underlying operating system 1030 functionality (e.g., kernel 1046, services 1048, or drivers 1032). The libraries 1018 may include system libraries 1018 (e.g., C standard library) that may provide functions such as memory allocation functions, string manipulation functions, mathematic functions, and the like. In addition, the libraries 1018 may include API libraries 1026 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1018 may also include a wide variety of other libraries 1022 to provide many other APIs to the applications 620 and other software components/modules.

The frameworks 1014 (also sometimes referred to as middleware) may provide a higher-level common infrastructure that may be utilized by the applications 1010 or other software components/modules. For example, the frameworks 1014 may provide various graphical UI functions, high-level resource management, high-level location services, and so forth. The frameworks 1014 may provide a broad spectrum of other APIs that may be utilized by the applications 1010 and/or other software components/modules, some of which may be specific to a particular operating system or platform.

The applications 1010 include built-in applications and/or third-party applications 642. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1042 may invoke the API calls 1058 provided by the mobile operating system such as the operating system 1030 to facilitate functionality described herein.

The applications 1010 may utilize built-in operating system functions, libraries (e.g., system libraries 1024, API libraries 1026, and other libraries 1044), or frameworks/middleware 1016 to create UIs to interact with users of the system. Alternatively, or additionally, in some systems, interactions with a user may occur through a presentation layer, such as the presentation layer 1008. In these systems, the application/module “logic” can be separated from the aspects of the application/module that interact with the user.

Some software architectures utilize virtual machines. In the example of FIG. 10, this is illustrated by a virtual machine 1004. The virtual machine 1004 creates a software environment where applications/modules can execute as if they were executing on a hardware machine. The virtual machine 1004 is hosted by a host operating system (e.g., the operating system 1030) and typically, although not always, has a virtual machine monitor 1028, which manages the operation of the virtual machine 1004 as well as the interface with the host operating system (e.g., the operating system 1030). A software architecture executes within the virtual machine 1004, such as an operating system 1030, libraries 1018, frameworks/middleware 1016, applications 1012, or a presentation layer 1008. These layers of software architecture executing within the virtual machine 1004 can be the same as corresponding layers previously described or may be different.

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1110 (e.g., software, a program, an application, an applet, an app, or other executable code) for causing the machine 1100 to perform any one or more of the methodologies discussed herein may be executed. As such, the instructions 1110 may be used to implement modules or components described herein. The instructions 1110 transform the general, non-programmed machine 1100 into a particular machine 1100 to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 1110, sequentially or otherwise, that specify actions to be taken by machine 1100. Further, while only a single machine 1100 is illustrated, the term “machine” shall also be taken to include a collection of machines that individually or jointly execute the instructions 1110 to perform any one or more of the methodologies discussed herein.

The machine 1100 may include processors 1104, memory memory/storage 1106, and I/O components 1118, which may be configured to communicate with each other such as via a bus 1102. The memory/storage 1106 may include a memory 1114, such as a main memory, or other memory storage, and a storage unit 1116, both accessible to the processors 1104 such as via the bus 1102. The storage unit 1116 and memory 1114 store the instructions 1110 embodying any one or more of the methodologies or functions described herein. The instructions 1110 may also reside, completely or partially, within the memory 1114 within the storage unit 1116, within at least one of the processors 1104 (e.g., within the processor's cache memory), or any suitable combination thereof, during execution thereof by the machine 1100. Accordingly, the memory 1114, the storage unit 1116, and the memory of processors 1104 are examples of machine-readable media.

The I/O components 1118 may include a wide variety of components to receive input, provide output, produce output, transmit information, exchange information, capture measurements, and so on. The specific I/O components 1118 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1118 may include many other components that are not shown in FIG. 11. The I/O components 1118 are grouped according to functionality merely for simplifying the following discussion and the grouping is in no way limiting. In various example embodiments, the I/O components 1118 may include output components 1126 and input components 1128. The output components 1126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1118 may include biometric components 1130, motion components 1134, environmental environment components 1136, or position components 1138 among a wide array of other components. For example, the biometric components 1130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1134 may include acceleration sensor components (e.g., accelerometer), gravitation sensor components, rotation sensor components (e.g., gyroscope), and so forth. The environment components 1136 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1138 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1118 may include communication components 1140 operable to couple the machine 1100 to a network 1132 or devices 1120 via coupling 1122 and coupling 1124, respectively. For example, the communication components 1140 may include a network interface component or other suitable device to interface with the network 1132. In further examples, communication components 1140 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1120 may be another machine or any of a wide variety of peripheral devices (e.g., a peripheral device coupled via a Universal Serial Bus (USB)).

Moreover, the communication components 1140 may detect identifiers or include components operable to detect identifiers. For example, the communication components 1140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140, such as, location via Internet Protocol (IP) geo-location, location via Wi-Fi® signal triangulation, location via detecting a NFC beacon signal that may indicate a particular location, and so forth.

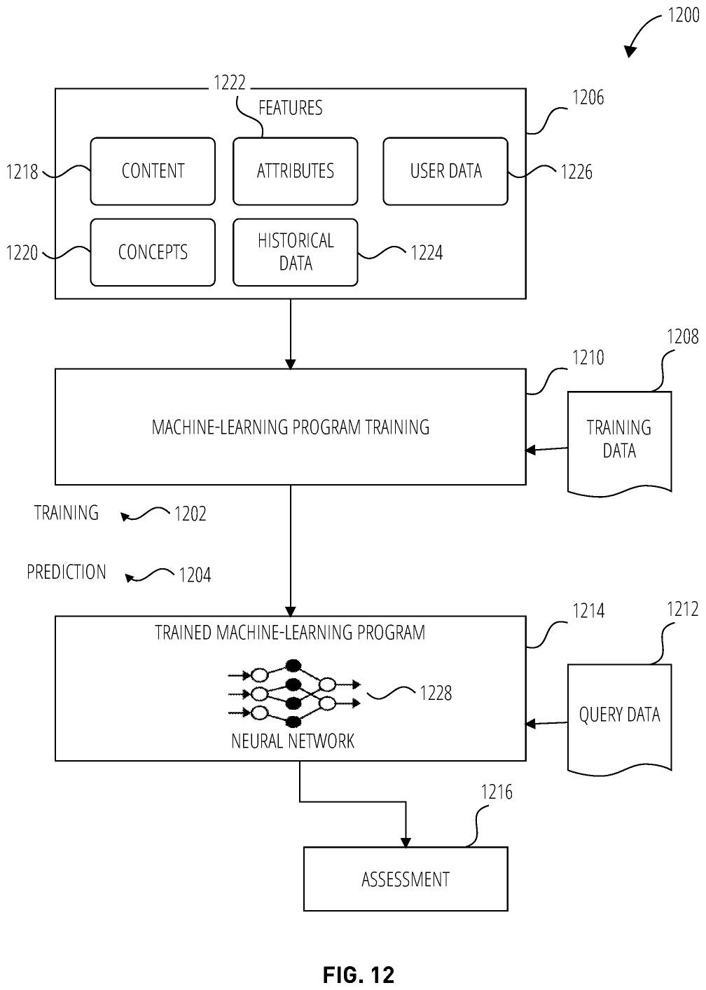

FIG. 12 is a block diagram showing a machine-learning program 1200 according to some examples. The machine-learning programs 1200, also referred to as machine-learning algorithms or tools, are used as part of the predictive trait system 320 system described herein, for instance to perform operations of trait-specific machine learning models (see FIG. 3 and FIG. 4).

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1208 in order to make data-driven predictions or decisions expressed as outputs or assessments (e.g., assessment 1216). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g., stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1200 supports two types of phases, namely a training phases 1202 and prediction phases 1204. In training phases 1202, supervised learning, unsupervised or reinforcement learning may be used. For example, the machine-learning program 1200 (1) receives features 1206 (e.g., as structured or labeled data in supervised learning) and/or (2) identifies features 1206 (e.g., unstructured or unlabeled data for unsupervised learning) in training data 1208 In prediction phases 1204, the machine-learning program 1200 uses the features 1206 for analyzing query data 1212 to generate outcomes or predictions, as examples of an assessment 1216.

In the training phase 1202, feature engineering is used to identify features 1206 and may include identifying informative, discriminating, and independent features for the effective operation of the machine-learning program 1200 in pattern recognition, classification, and regression. In some examples, the training data 1208 includes labeled data, which is known data for pre-identified features 1206 and one or more outcomes. Each of the features 1206 may be a variable or attribute, such as individual measurable property of a process, article, system, or phenomenon represented by a data set (e.g., the training data 1208). Features 1206 may also be of different types, such as numeric features, strings, and graphs, and may include one or more of content 1218, concepts 1220, attributes 1222, historical data 1224 and/or user data 1226, merely for example.

In training phases 1202, the machine-learning program 1200 uses the training data 1208 to find correlations among the features 1206 that affect a predicted outcome or assessment 1216.

With the training data 1208 and the identified features 1206, the machine-learning program 1200 is trained during the training phase 1202 at machine-learning program training 1210. The machine-learning program 1200 appraises values of the features 1206 as they correlate to the training data 1208. The result of the training is the trained machine-learning program 1214 (e.g., a trained or learned model).

Further, the training phases 1202 may involve machine learning, in which the training data 1208 is structured (e.g., labeled during preprocessing operations), and the trained machine-learning program 1214 implements a relatively simple neural network 1228 (or one of other machine learning models, as described herein) capable of performing, for example, classification and clustering operations. In other examples, the training phase 1202 may involve deep learning, in which the training data 1208 is unstructured, and the trained machine-learning program 1214 implements a deep neural network 1228 that is able to perform both feature extraction and classification/clustering operations.

A neural network 1228 generated during the training phase 1202, and implemented within the trained machine-learning program 1214, may include a hierarchical (e.g., layered) organization of neurons. For example, neurons (or nodes) may be arranged hierarchically into a number of layers, including an input layer, an output layer, and multiple hidden layers. The layers within the neural network 1228 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1228 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), merely for example.

During prediction phases 1204 the trained machine-learning program 1214 is used to perform an assessment. Query data 1212 is provided as an input to the trained machine-learning program 1214, and the trained machine-learning program 1214 generates the assessment 1216 as output, responsive to receipt of the query data 1212.

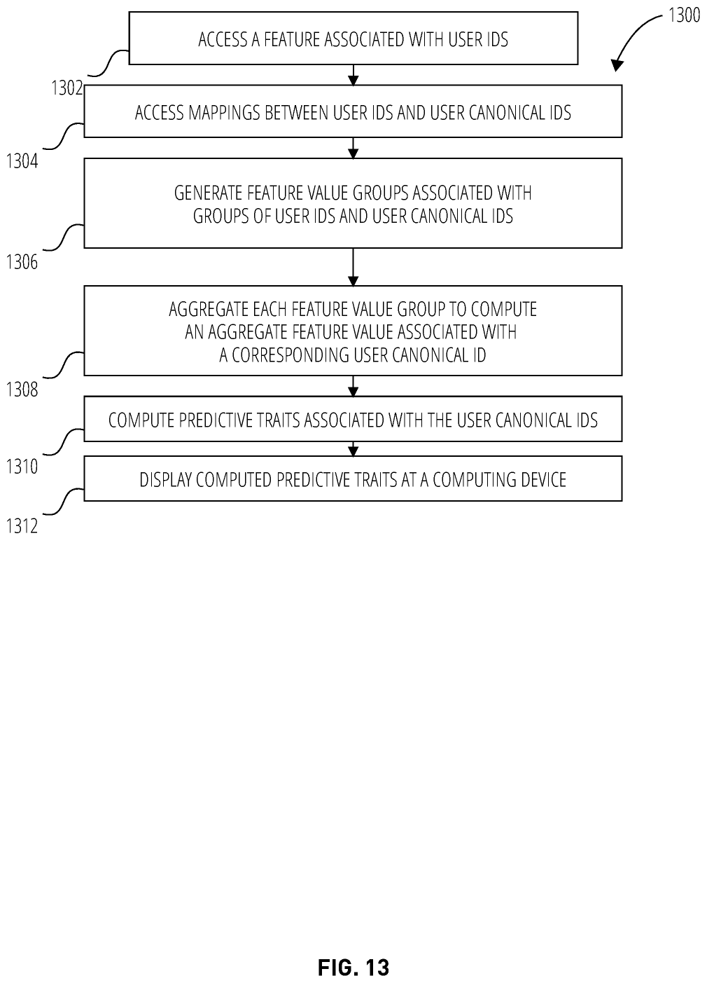

FIG. 13 illustrates an example method 1300 for feature aggregation, as implemented by the feature generation system 214 and/or predictive trait system 320, according to some examples. Although the example method 1300 depicts a particular sequence of operations, the sequence may be altered without departing from the scope of the present disclosure. For example, some of the operations depicted may be performed in parallel or in a different sequence that does not materially affect the function of the method 1300. In other examples, different components of an example device or system that implements the method 1300 may perform functions at substantially the same time or in a specific sequence.

At operation 1302, the feature generation system 214 accesses a feature associated with one or more user IDs. At operation 1304, the feature generation system 214 accesses a structure specifying mappings between user IDs and user canonical IDs (e.g., multiple user IDs are found to correspond to a unique underlying user canonical view or user ID).

At operation 1306, the feature generation system 214 generates feature value groups, each feature value group associated with a group of user IDs corresponding to the same underlying user canonical ID. At operation 1308, the feature generation system 214 aggregates the values in each feature value group to compute an aggregate feature value associated with the relevant user canonical ID.

At operation 1310, the feature generation system 214 can provide the aggregate feature values to a predictive trait system 320 to be used in the computation of predictive traits associated with the user canonical IDs (e.g., the feature generation system 214 can be a component of, or an input to, the predictive trait system 320). At operation 1312, the predictive trait system 320 can display the computed predictive traits at a computing device.

### EXAMPLES

Example 1 is a system comprising: one or more computer memories; one or more processors; and a set of instructions stored in the one or more computer memories that cause the one or more processors to perform operations, the operations comprising: accessing a feature associated with a plurality of user identities (IDs); accessing a structure specifying mappings between the plurality of user IDs and a plurality of user canonical IDs; generating groups of feature values of the feature based on the mappings, each group of feature values being associated with a corresponding group of user IDs of the plurality of user IDs and with a corresponding user canonical ID of the plurality of the user canonical IDs; aggregating each group of feature values to calculate an aggregate feature value of the feature, each aggregate feature value associated with the corresponding user canonical ID; computing predictive traits associated with the plurality of user canonical IDs, the predictive traits comprising likelihoods of events or trait values associated with the user canonical IDs, the computation of the predictive traits using the aggregate feature values associated with the corresponding user canonical IDs; and causing display, at a user interface (UI) of a computing device, of the computed predictive traits.

In Example 2, the subject matter of Example 1 includes, wherein the feature has a feature type, the feature type being one of at least raw count-based type, exponentially decaying count-based type, rate-based type, time-since-last-event type, time-since-first-event type, average-duration-between-events type, or number-of-events type.

In Example 3, the subject matter of Examples 1-2 includes, wherein the feature is a trait feature based on a trait associated with one of more user IDs of the plurality of user IDs.

In Example 4, the subject matter of Examples 2-3 includes, wherein aggregating each group of feature values of the feature comprises using an aggregation computation associated with the feature type.

In Example 5, the subject matter of Example 4 includes, wherein the feature type is the raw count-based feature type, and the aggregation computation uses a sum function.

In Example 6, the subject matter of Examples 4-5 includes, wherein the feature type is the exponentially decaying count-based type, and the aggregation computation uses a sum function.

In Example 7, the subject matter of Examples 4-6 includes, wherein the feature type is the rate-based type, and the aggregation computation combines partial information used to compute the group of feature values.

In Example 8, the subject matter of Examples 4-7 includes, wherein the feature type is the time-since-last-event type, and the aggregation computation uses a min function.

In Example 9, the subject matter of Examples 4-8 includes, wherein the feature type is the time-since-first-event type, and the aggregation computation uses a max function.

In Example 10, the subject matter of Examples 4-9 includes, wherein the feature type is the average-duration-between-events type, and the aggregation computation uses at least one of a feature of the time-since-first-event type, a feature of the time-since-last-event type, and a feature of the number-of-events type.

In Example 11, the subject matter of Examples 3-10 includes, wherein an aggregation computation uses a priority function to select among values in the group of feature values for the trait feature.

Example 12 is at least one non-transitory, machine-readable medium including instructions that, when executed by processing circuitry, cause the processing circuitry to perform operations to implement of any of Examples 1-11.

Example 13 is an apparatus comprising means to implement of any of Examples 1-11.

Example 14 is a method to implement of any of Examples 1-11.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per sc.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly con figures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
one or more computer memories;
one or more processors; and
a set of instructions stored in the one or more computer memories that cause the one or more processors to perform operations, the operations comprising:
accessing a feature associated with a plurality of user identities (IDs);
accessing a structure specifying mappings between the plurality of user IDs and a plurality of user canonical IDs;
generating groups of feature values of the feature based on the mappings, each group of feature values being associated with a corresponding group of user IDs of the plurality of user IDs and with a corresponding user canonical ID of the plurality of the user canonical IDs;
aggregating each group of feature values to calculate an aggregate feature value of the feature, each aggregate feature value associated with the corresponding user canonical ID;
computing predictive traits associated with the plurality of user canonical IDs, the predictive traits comprising likelihoods of events or trait values associated with the user canonical IDs, the computation of the predictive traits using the aggregate feature values associated with the corresponding user canonical IDs; and
causing display, at a user interface (UI) of a computing device, of the computed predictive traits.

2. The system of claim 1, wherein the feature has a feature type, the feature type being one of at least raw count-based type, exponentially decaying count-based type, rate-based type, time-since-last-event type, time-since-first-event type, average-duration-between-events type, or number-of-events type.

3. The system of claim 1, wherein the feature is a trait feature based on a trait associated with one of more user IDs of the plurality of user IDs.

4. The system of claim 2, wherein aggregating each group of feature values of the feature comprises using an aggregation computation associated with the feature type.

5. The system of claim 4, wherein the feature type is the raw count-based feature type, and the aggregation computation uses a sum function.

6. The system of claim 4, wherein the feature type is the exponentially decaying count-based type, and the aggregation computation uses a sum function.

7. The system of claim 4, wherein the feature type is the rate-based type, and the aggregation computation combines partial information used to compute the group of feature values.

8. The system of claim 4, wherein the feature type is the time-since-last-event type, and the aggregation computation uses a min function.

9. The system of claim 4, wherein the feature type is the time-since-first-event type, and the aggregation computation uses a max function.

10. The system of claim 4, wherein the feature type is the average-duration-between-events type, and the aggregation computation uses at least one of a feature of the time-since-first-event type, a feature of the time-since-last-event type, and a feature of the number-of-events type.

11. The system of claim 3, wherein an aggregation computation uses a priority function to select among values in the group of feature values for the trait feature.

12. A computer-implemented method, comprising:
accessing a feature associated with a plurality of user IDs;
accessing a structure specifying mappings between the plurality of user IDs and a plurality of user canonical IDs;
generating groups of feature values of the feature based on the mappings, each group of feature values being associated with a corresponding group of user IDs of the plurality of user IDs and with a corresponding user canonical ID of the plurality of the user canonical IDs;
aggregating each group of feature values to calculate an aggregate feature value of the feature, each aggregate feature value associated with the corresponding user canonical ID;
computing predictive traits associated with the plurality of user canonical IDs, the predictive traits comprising likelihoods of events or trait values associated with the user canonical IDs, the computation of the predictive traits using the aggregate feature values associated with the corresponding user canonical IDs; and
causing display, at UI of a computing device, of the computed predictive traits.

13. The method of claim 12, wherein the feature has a corresponding feature type, the corresponding feature type being one of at least raw count-based type, exponentially decay count-based type, rate-based type, time-since-last-event type, time-since-first-event type, average-duration-between-events type, or number-of-events type.

14. The method of claim 12, wherein the feature is a trait feature based on a trait associated with one of more IDs of the plurality of IDs.

15. The method of claim 13, wherein aggregating each group of feature values of the feature comprises using an aggregation computation associated with the feature type.

16. The method of claim 15, wherein the feature type is the raw count-based feature type, and the aggregation computation uses a sum function.

17. The method of claim 15, wherein the feature type is the exponentially decaying count-based type, and the aggregation computation uses a sum function.

18. The method of claim 15, wherein the feature type is the rate-based type, and the aggregation computation combines partial information used to compute the group of feature values.

19. The method of claim 15, wherein the feature type is the average-duration-between-events type, and the aggregation computation uses a feature of the time-since-first-event type, a feature of the time-since-last-event type, and a feature of the number-of-events type.

20. A non-transitory computer-readable storage medium, the computer-readable storage medium including instructions that when executed by at least one processor, cause the at least one processor to:
access a feature associated with a plurality of user IDs;
access a structure specifying mappings between the plurality of user IDs and a plurality of user canonical IDs;
generate groups of feature values of the feature based on the mappings, each group of feature values being associated with a corresponding group of user IDs of the plurality of user IDs and with a corresponding user canonical ID of the plurality of the user canonical IDs;
aggregate each group of feature values to calculate an aggregate feature value of the feature, each aggregate feature value associated with the corresponding user canonical ID;
compute predictive traits associated with the plurality of user canonical IDs, the predictive traits comprising likelihoods of events or trait values associated with the user canonical IDs, the computation of the predictive traits using the aggregate feature values associated with the corresponding user canonical IDs; and
cause display, at a UI of a computing device, of the computed predictive traits.
